(19) United States
(12) Patent Application Publication
(10) Pub. No.: US 2023/0330985 A1
(43) Pub. Date: Oct. 19, 2023

(54) MAGNETIC CYLINDER PARTICULARLY FOR A DEVICE FOR PRINTING AND A METHOD FOR PRODUCING THE MAGNETIC CYLINDER

(71) Applicant: ROTOMETAL DBN SP. Z O.O., Swiebodzin (PL)

(72) Inventor: Miroslaw Jan MAZUREK, Brojce (PL)

(73) Assignee: ROTOMETAL DBN SP. Z O.O., Swiebodzin (PL)

(21) Appl. No.: 18/025,115

(22) PCT Filed: Oct. 30, 2020
(86) PCT No.: PCT/IB2020/060214

§ 371 Date: Mar. 7, 2023

(30) Foreign Application Priority Data
Sep. 8, 2020 (PL) P.435225

(51) Int. Cl. B41F 27/02; B41F 13/10

(52) U.S. Cl. CPC B41F 27/02; B41F 13/10

(57) ABSTRACT

The object of the invention is a magnetic cylinder, in particular for a device for printing, having a cylindrical body and two bearers mounted at the ends of the body, wherein at least one bearer includes a cylindrical flange adjacent to the body, wherein a plurality of magnetic channels are formed in the body extending substantially parallel to the longitudinal axis of the body, radially spaced from the longitudinal axis of the body, wherein corresponding magnetic assemblies are inserted into the magnetic channels. The object of the invention is also a method for producing the magnetic cylinder.

The object of the invention is a magnetic cylinder, in particular for a device for printing, and a method for producing the magnetic cylinder, in particular for a device for printing. The objects of the present invention are applicable in the operations of cutting, incising, perforating or printing a material in the form of a substrate.

In one of the solutions commonly used in devices for printing, in particular in die-cutting machines, flexible dies, which are a tool performing a desired operation on the substrate, are fixed to a rotating cylinder of the device for printing, inter alia with the use of magnetic force holding the flexible die on the surface of the magnetic cylinder. Magnetic cylinder solutions known in the prior art provide for the fixing of magnets in grooves made on the surface of the magnetic cylinder. However, it will be appreciated that the working surface of the magnetic cylinder is often exposed to mechanical damage by the operator of the device for printing due to improper use of the tool (i.e. the magnetic cylinder). As a result, ferrite magnets, which magnetic assemblies consist of, are often subject to cracking, chipping or other mechanical damage.

U.S. Pat. No. 3,097,598A describes a printing cylinder for magnetically holding flexible printing plates. The disclosed printing cylinder comprises co-axial elements, each having a soft iron annular member and at least one permanent magnet magnetized across its thinnest section. The permanent magnet is affixed to the face of the member. The annular member also comprises longitudinal ribs of non-ferromagnetic material. The co-axial elements of the printing cylinder are mounted in axial adjacency on the ribs in such manner as to provide closely spaced poles of alternating polarity in the peripheral surface of the cylinder.

U.S. Pat. No. 3,721,189A describes a magnetic print cylinder for use with flexible and magnetizable printing plates. The magnetic print cylinder has a plurality of axially extending magnetic assemblies mounted side by side on its surface. Each assembly comprises a channel member made of a magnetic flux insulating material. The cylinder further has a plurality of permanent magnetic parts arranged in a spaced relation from the channel member, and a magnetizable pole piece positioned between each pair of magnets. The outer surface of the magnetic assemblies forms the plate mounting surface for the printing plates.

U.S. Pat. No. 3,742,852A describes a magnetic print cylinder specifically for holding related structures such as flexible dies or printing plates that contain magnetic material. The cylinder utilizes compressible elastic means with permanent magnets embedded in an elastomeric material, wherein each means with permanent magnets is kept compressed in the finished cylinder and in conjunction with the holding means such that their surfaces are in close contact with associated magnetic rings. The magnetic print cylinder thus created provides better performance and, in addition, the compression state of the means with permanent magnets makes them more reliably maintained by friction in suitable holding means.

U.S. Pat. No. 4,823,697A discloses a printing plate cylinder with magnets placed therein. The printing plate cylinder comprises an elongate member formed of a material constituting a good magnetic conductor and having a cylindrical configuration. The elongate member comprises opposite axial end portions and a central portion connecting them. The elongate member is fixed while ensuring its rotation about its longitudinal central axis, which is parallel to and eccentric to the longitudinal central axis of the elongate member. When the elongate member is in a first position, the central portion of the elongate member is spaced away from a magnetic printing plate secured to the printing plate cylinder. In the first position of the elongate member, a magnetic field is established through the magnetic printing plate. When the elongate member is in a second position, the central portion of the elongate member is adjacent to the magnetic printing plate. In the second position of the elongate member, the action of the magnetic field on the printing plate is partially terminated to provide ease of removing the magnetic printing plate from the printing plate cylinder.

U.S. Pat. No. 5,711,223A relates to a magnetic cylinder for a printing press, comprising an outer cylinder member having circumferentially and axially spaced plugs of magnetic material or axially spaced apart rings of magnetic material for directing a magnetic field in such a way as to hold a magnetic printing plate on the outer surface of the outer cylinder member. An inner cylinder member comprises circumferentially and axially spaced permanent magnet members supported on a cylinder of non-magnetic material or stacked circular ring magnets interposed between rings of magnetic or non-magnetic material for generating a magnetic field passing through the plugs or rings of magnetic material on the outer cylinder member. The inner cylinder member is disposed to form a radial air gap between the outer cylinder member and an outer surface of the inner cylinder member. The inner cylinder member can be rotated or axially moved relative to the outer cylinder member to change the intensity of the magnetic field to provide for positioning a printing plate on or removing a printing plate from the outer cylinder member. Ring magnets on the inner cylinder member may be of conventional polarization with poles on opposite side faces of the ring or with poles formed on the radially inner and outer circumferential surfaces of the ring.

European patent application EP0266445A1 discloses magnetic cylinders with an image plate or a blanket plate with a flexible die, having annular pole pieces and magnets which maximize either the resistance of the plate to peel-off or the attractive force intensity with a nominal displacement of the plate from the cylinder for typical operating conditions The plates are precurved, preferably with a radius slightly less than the cylinder radius.

The technical problem for the present invention to solve is to propose a magnetic cylinder which will be specifically intended fora device for printing and which will exhibit increased resistance to damage and thus improved reliability. Furthermore, it is desirable to provide a magnetic cylinder having a uniform and homogeneous distribution of the magnetic field on the outer surface, thereby providing a secure grip on the flexible die fixed thereto. Additionally, it is desirable to have a magnetic cylinder exhibiting capability to have its characteristics modified, including the distribution of the magnetic field generated on its outer surface, while allowing for easy performance of this operation as well as its servicing operation. In addition, it is desirable to provide a method for producing the magnetic cylinder to solve the technical problems defined above.

The first object of the invention is a magnetic cylinder, in particular for a device for printing, comprising a cylindrical body and two bearers mounted at the ends of the body, wherein at least one bearer comprises a cylindrical flange adjacent to the body, characterized in that there is a plurality of magnetic channels formed in the body extending substantially parallel to the longitudinal axis of the body, radially spaced from the longitudinal axis of the body, wherein corresponding magnetic assemblies are inserted into the magnetic channels.

In a preferred embodiment of the invention, the plurality of magnetic channels are arranged at equal intervals in the peripheral region of the body near its outer surface, with a constant radial distance from the longitudinal axis of the body maintained.

In a further preferred embodiment of the invention, the bearer is fixed to the body by means of mounting screws passing through holes in the flange.

In a further preferred embodiment of the invention, the magnetic assembly comprises a plurality of permanent magnets, fixed on a fixing rod, wherein each permanent magnet is separated from the adjacent permanent magnet by a spacer.

Preferably, the permanent magnets are positioned on the fixing rod with alternating polarity in such manner that the same polarity of the permanent magnet is provided on both sides of the spacer.

Equally preferably, the fixing rod comprises an external thread.

Even more preferably, the magnetic assembly at at least one end is secured with a nut.

In a preferred embodiment of the invention, the fixing rod is made of non-ferrous metal.

In a further preferred embodiment of the invention, on the contact surface of the bearers receiving holes are formed into which the ends of magnetic assemblies are inserted.

In a further preferred embodiment of the invention, the body is made of a magnetic flux insulating material.

Preferably, the diameter of the bearer flange is larger relative to the diameter of the body. The difference between the diameter of the bearer flange and the diameter of the body corresponds to the thickness of the flexible die mounted to the magnetic cylinder.

Equally preferably, on the outer surface of the body a plurality of seats are arranged into which additional permanent magnets are inserted.

More preferably, the seats are arranged on the surface of the body in a straight line running parallel to the longitudinal axis of the magnetic cylinder, with a constant distance from adjacent seats maintained.

The second object of the invention is a method for producing the magnetic cylinder, in particular for a device for printing, characterized in that it comprises the following steps:
a) a plurality of magnetic channels extending substantially parallel to the longitudinal axis of the body are made in the body,
b) magnetic assemblies are inserted into the magnetic channels,
c) bearers are fixed to side surfaces of the body.

In a preferred embodiment of the invention, in step a) a plurality of magnetic channels arranged at equal intervals are made in the peripheral region of the body near its outer surface, with a constant radial distance from the longitudinal axis of the body maintained.

In a further preferred embodiment of the invention, in step c) the bearers are fixed to the body by means of mounting screws passing through holes in the flange.

In a further preferred embodiment of the invention, before step c) on the contact surface of the bearers receiving holes are made into which the ends of magnetic assemblies are inserted.

Preferably, in step b) epoxy adhesive is put into the magnetic channels.

Equally preferably, on the outer surface of the body a plurality of seats are made into which additional permanent magnets are inserted.

More preferably, the seats are arranged on the surface of the body in a straight line running parallel to the longitudinal axis of the magnetic cylinder, with a constant distance from adjacent seats maintained.

The magnetic cylinder of the present invention is specifically intended for a device for printing, including for a die-cutting machine. The placing of magnetic assemblies inside the body of the magnetic cylinder, beneath its outer surface, prevents damage to the permanent magnets themselves, while additionally allowing for the outer surface of the body to be treated in order to increase its hardness and durability (strength). Accordingly, increased resistance to damage and thus improved reliability of the magnetic cylinder itself was obtained. Moreover, the uniform arrangement of the magnetic channels and their location in the peripheral region of the body, near the outer surface thereof, helped to ensure a uniform and homogeneous distribution of the magnetic field on the outer surface, which translates directly into a secure grip on the flexible die fixed thereto. Owing to the use of detachable fixing of the bearers to the body and the magnetic assemblies inserted into the magnetic channels, the possibility to change characteristics was allowed for, including the distribution of the magnetic field generated on its outer surface.

Furthermore, such construction of the magnetic cylinder allows for easy performance of this operation as well as its servicing operation. The use of a magnetic assembly built from a threaded fixing rod with permanent magnets placed thereon and additionally secured at at least one end (preferably at both ends) with nuts ensures more reliable fixing of permanent magnets, which significantly reduces the risk of longitudinal displacement of the permanent magnets on the fixing rod. In addition, in order to prevent small radial shifts of the magnetic assemblies, these were fixed in the magnetic channels using epoxy adhesive to secure them against moving and to keep the magnetic assemblies in place. In addition, the use of additional permanent magnets arranged in a series of seats made on the surface of the magnetic cylinder body allows for a better grip on the flexible die on the surface of the body, in particular in the region of one of the ends of the flexible die.

The solution according to the invention is presented in the following embodiments and is illustrated in the drawing, in which

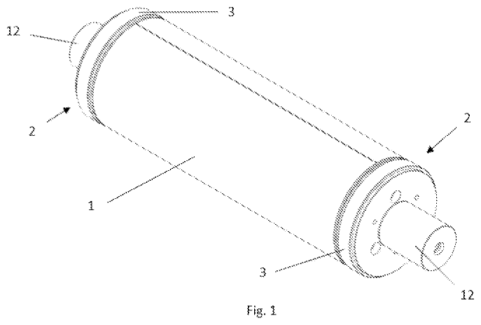

FIG. 1 shows an axonometric view of a magnetic cylinder according to the first embodiment of the present invention,

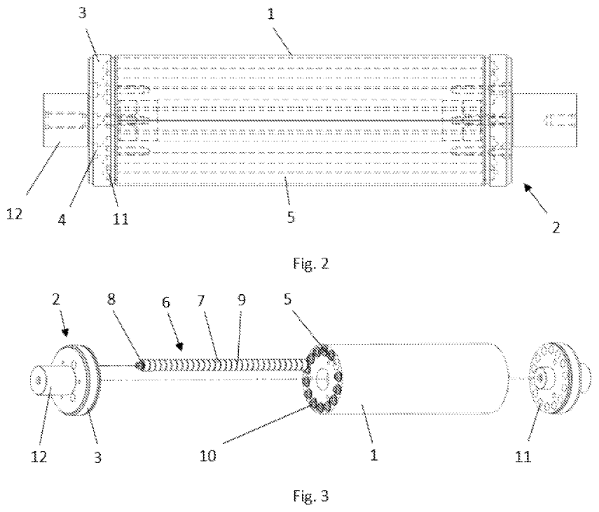

FIG. 2 shows a side view with shown inner structures of the magnetic cylinder of FIG. 1,

FIG. 3 shows an exploded axonometric view of the magnetic cylinder of FIG. 1,

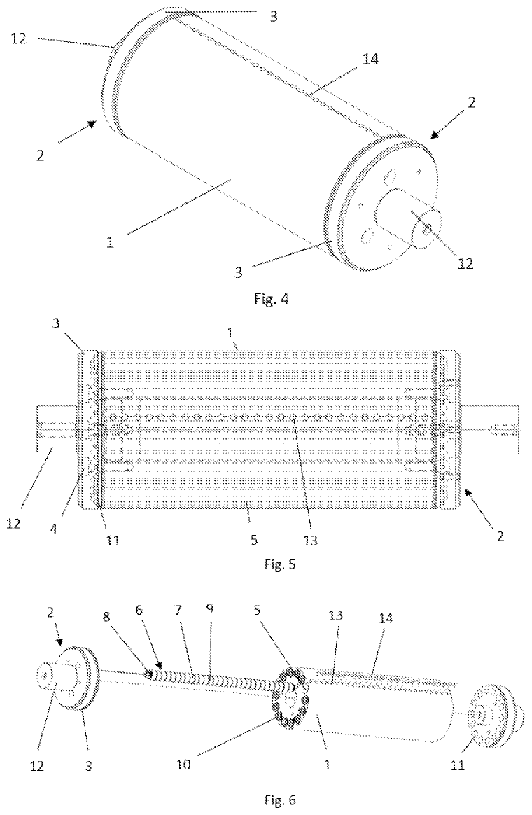

FIG. 4 shows an axonometric view of the magnetic cylinder according to the second embodiment of the present invention,

FIG. 5 shows a side view with shown inner structures of the magnetic cylinder of FIG. 4, and

FIG. 6 shows an exploded axonometric view of the magnetic cylinder of FIG. 4.

### EXAMPLE 1

The first embodiment of the magnetic cylinder of the present invention is illustrated in FIGS. 1-3 The magnetic cylinder shown in the present embodiment is intended for a device for printing, wherein flexible dies used in a given die-cutting operation are fixed on the magnetic cylinder by means of magnetic force. The magnetic cylinder shown in the present embodiment comprises a body 1 and two bearers 2 mounted at the ends of the body 1. The bearers 2 are in the form of an axle with a cylindrical flange 3 located closer to one of its ends. The nominal diameter of the flange 3 is increased relative to the nominal diameter of the body 1 by a value corresponding to the thickness of the flexible die fixed on the cylinder. The bearers 2 are fixed to the body 1 by means of mounting screws 4 such that the cylindrical flange 3 adheres to the edge of the body 1.

In the present embodiment, the body 1 is made of a magnetic flux insulating material, in this case aluminium. The material of which the body 1 is made does not constitute a limitation to the scope of the present invention, and in alternative embodiments other materials for the body 1 of the magnetic cylinder may be used provided that the desired magnetic flux insulation is ensured. Therefore, examples of said materials for the body 1 include non-ferrous metals (e.g. brass) or stainless steel.

As best illustrated in FIG. 2 and FIG. 3, in the body 1, along its entire length, through holes are made, forming magnetic channels 5. The magnetic channels 5 formed, for example, by a drilling operation, extend substantially parallel to the longitudinal axis of the magnetic cylinder, at an equal radial distance from the longitudinal axis of the magnetic cylinder. The magnetic channels 5 are located at a short distance from the outer surface of the body 1 to ensure desired distribution and intensity of the magnetic field on the surface of the body 1. In the present embodiment, fourteen magnetic channels 5 have been made in the body 1, arranged uniformly in the peripheral region of the body 1. The number of magnetic channels 5 as well as their geometrical arrangement in the body 1 do not constitute a limitation to the scope of the invention, and in alternative embodiments, it is possible to use a greater or smaller number of magnetic channels 5 arranged in various arrays and geometries, provided that the desired distribution and intensity of the magnetic field on its outer surface is ensured.

As shown in FIG. 3, magnetic assemblies 6 are inserted into the magnetic channels 5. Each single magnetic assembly 6 comprises a plurality of permanent magnets 7, fixed on a fixing rod 8, wherein each permanent magnet 7 is separated from the adjacent permanent magnet 7 by a spacer 9. In the present embodiment, the fixing rod 8 is produced from brass, while spacers 9 are made of steel. The materials used to make the fixing rod 8 as well as the spacers 9 are not limited to those shown in the present embodiment and in alternative embodiments different building materials may be used provided that desired properties of these elements are ensured. Furthermore, the fixing rod 8 used in the present embodiment is threaded (i.e. it includes an external thread), which provides a more reliable fixing of permanent magnets 7 thereon, while significantly reducing the risk of longitudinal displacement on the fixing rod 8.

When being placed on the fixing rod 8, the permanent magnets 7 are rotated alternately in such manner that the same polarity of the permanent magnet 7 is ensured on both sides of the spacer 9. The magnetic assemblies 6 are secured at each end with nuts 10 (for example, made of steel), preventing the displacement and falling out of the permanent magnets 7. The whole forms a magnetic strip together, which is then inserted into the magnetic channels 5 formed previously in the body 1.

As can be seen in FIG. 2 and FIG. 3, the length of the magnetic assembly 6 is equal to the length of the magnetic cylinder body 1, while the total length of the magnetic strip is greater than the length of the body 1. This is because the magnetic strip includes a magnetic assembly 6 with nuts 10 affixed to its ends, increasing the total length of the magnetic strip. Accordingly, in the present embodiment, on the contact surfaces of the flange 3 of both bearers 2 receiving holes 11 are made (for example, in a drilling operation) into which protruding ends of the magnetic strip (including the nut 10) are inserted. In the present embodiment, the receiving holes 11 are made as non-through holes and are located on the contact surfaces of the flange 3 of both bearers 2, however, in alternative embodiments, it is possible to make the receiving holes only on one bearer 2, wherein the receiving holes 11 may also be through holes.

For clarity, the embodiment of the magnetic cylinder of the present invention shown in FIG. 1-3 further comprises fixing shafts 12, located on the outer side surfaces of the flange 3 of the bearer 2. The fixing shafts 12 are adapted for fixing to a suitable drive system of the target device for printing.

The method for producing the magnetic cylinder specified in the present embodiment comprises the following steps:
a) a plurality of magnetic channels 5 extending substantially parallel to the longitudinal axis of the body 1 are made in the body 1,
b) magnetic assemblies 6 are inserted into the magnetic channels 5,
c) bearers 2 are fixed to the side surfaces of the body 1.

Step a) of the depicted method may, for example, be implemented by a drilling operation, in particular by means of a computerized numerical control (CNC) machine tool. In order to maintain the arrangement of the magnetic channels 5 in the magnetic cylinder as specified in this embodiment, in step a) a plurality of magnetic channels 5 arranged at equal intervals are made in the peripheral region of the body 1 near its outer surface, with a constant radial distance from the longitudinal axis of the body 1 maintained. Furthermore, given the increased length of the magnetic strip formed by the magnetic assembly 6 secured with the nuts 10, before step c) on the contact surface of the flange 3 of the bearer 2 receiving holes 11 are made into which the ends of the magnetic assemblies 6 are inserted.

In addition, in step c) the bearers 2 are fixed to the body 1 by means of mounting screws 4 passing through holes in the flange 3, thus ensuring that bearers 2 are detachably fixed to the body 1.

Significantly, in step b) epoxy adhesive is put into the magnetic channels 5. The mounting of the magnetic assemblies 6 using epoxy adhesive helps to prevent small radial shifts of the magnetic assemblies 6 and ensures that these are held in the right place.

### EXAMPLE 2

The second embodiment of the magnetic cylinder of the present invention is illustrated schematically in FIGS. 3-5. The construction of a magnetic cylinder according to the second embodiment of the present invention is substantially analogous to the construction of the magnetic cylinder according to the first embodiment of the present invention, therefore, for clarity of the present disclosure, a description of analogous construction elements is omitted.

Unlike the first embodiment, the magnetic cylinder according to the second embodiment further comprises, on the outer surface of the body 1, a plurality of seats 13 receiving additional permanent magnets 14. In this embodiment, the seats 13 are arranged on the surface of the body 1 in a straight line running parallel to the longitudinal axis of the magnetic cylinder, with a constant distance from the adjacent seats 13 maintained. In the present embodiment, illustrated in FIG. 3-5, twenty-seven seats 13 are arranged on the outer surface of the body 1, made in the form of circular drilled holes in which twenty-seven additional permanent magnets 14 adopting the shape of a cylinder are arranged accordingly. The number, arrangement as well as shape of the seats 13 and their corresponding additional permanent magnets 14 do not limit the scope of the present invention, and in alternative embodiments, it is possible to use a smaller or larger number of seats 13 arranged on the surface of the body 1 in another configuration and embodied in a different shape with additional permanent magnets 14 matching this shape.

The method for producing the magnetic cylinder depicted in the present embodiment is substantially analogous to the method for producing the magnetic cylinder depicted in the first embodiment, with the difference that it further comprises a step wherein on the outer surface of the body 1 a plurality of seats 13 are made into which additional permanent magnets 14 are inserted. Significantly, the seats 13 are arranged on the surface of the body 1 in a straight line running parallel to the longitudinal axis of the magnetic cylinder, with a constant distance from the adjacent seats 13 maintained.

### LIST OF REFERENCE NUMBERS

1—body
2—bearer
3—flange
4—mounting screw
5—magnetic channel
6—magnetic assembly
7—permanent magnet
8—fixing rod
9—spacer
10—nut
11—receiving hole
12—fixing shaft
13—seat
14—additional permanent magnet

1. A magnetic cylinder, in particular for a device for printing, comprising a cylindrical body and two bearers mounted at the ends of the body, wherein at least one bearer comprises a cylindrical flange adjacent to the body, wherein a plurality of magnetic channels are formed in the body extending substantially parallel to the longitudinal axis of the body, radially spaced from the longitudinal axis of the body, wherein corresponding magnetic assemblies are inserted into the magnetic channels.

2. The magnetic cylinder according to claim 1, wherein the plurality of magnetic channels are arranged at equal intervals in the peripheral region of the body near its outer surface, with a constant radial distance from the longitudinal axis of the body maintained.

3. The magnetic cylinder according to claim 1, wherein the bearer is fixed to the body by means of mounting screws passing through holes in the flange.

4. The magnetic cylinder according to claim 1, wherein the magnetic assembly comprises a plurality of permanent magnets, fixed on a fixing rod, wherein each permanent magnet is separated from the adjacent permanent magnet by a spacer.

5. The magnetic cylinder according to claim 4, wherein permanent magnets are positioned on the fixing rod with alternating polarity in such manner that the same polarity of the permanent magnet is provided on both sides of the spacer.

6. The magnetic cylinder according to claim 4, wherein the fixing rod comprises an external thread.

7. The magnetic cylinder according to claim 4, wherein the magnetic assembly at least one end is secured with a nut.

8. The magnetic cylinder according to claim 4, wherein the fixing rod is made of non-ferrous metal.

9. The magnetic cylinder according to claim 4, wherein on the inner surface of the bearer receiving holes are formed into which the ends of magnetic assemblies are inserted.

10. The magnetic cylinder according to claim 1, wherein the body is made of a magnetic flux insulating material.

11. The magnetic cylinder according to claim 1, wherein the diameter of the flange is larger relative to the diameter of the body.

12. The magnetic cylinder according to claim 1, wherein on the outer surface of the body a plurality of seats are arranged into which additional permanent magnets are inserted.

13. The magnetic cylinder according to claim 12, wherein the seats are arranged on the surface of the body in a straight line running parallel to the longitudinal axis of the magnetic cylinder, with a constant distance from the adjacent seats maintained.

14. A method for making a magnetic cylinder, wherein it comprises the following steps:
a) a plurality of magnetic channels extending substantially parallel to the longitudinal axis of the body are made in the body,
b) magnetic assemblies are inserted into the magnetic channels,
c) bearers are fixed to the side surfaces of the body.

15. The method for making the magnetic cylinder according to claim 14, wherein in step a) a plurality of magnetic channels arranged at equal intervals are made in the peripheral region of the body near its outer surface, with a constant radial distance from the longitudinal axis of the body maintained.

16. The method for making the magnetic cylinder according to claim 14, wherein in step c) the bearers are fixed to the body by means of mounting screws passing through holes in the flange.

17. The method for making the magnetic cylinder according to claim 14, wherein before step c) on the contact surface of the flange of the bearer receiving holes are produced into which the ends of magnetic assemblies are inserted.

18. The method for making the magnetic cylinder according to claim 14, wherein in step b) epoxy adhesive is put into the magnetic channels.

19. The method for making the magnetic cylinder according to claim 14, wherein on the outer surface of the body a plurality of seats are made into which additional permanent magnets are inserted.

20. The method for making the magnetic cylinder according to claim 19, wherein the seats are arranged on the surface of the body in a straight line running parallel to the longitudinal axis of the magnetic cylinder, with a constant distance from the adjacent seats maintained.
